(19) United States
(12) Patent Application Publication
(10) Pub. No.: US 2014/0017002 A1
(43) Pub. Date: Jan. 16, 2014

(54) ADAPTER CLIP FOR OLD CONSTRUCTION BOX

(71) Applicant: Lloyd Barnes, West Valley City, UT (US)

(72) Inventor: Lloyd Barnes, West Valley City, UT (US)

(21) Appl. No.: 14/031,022

(22) Filed: Sep. 18, 2013

Related U.S. Application Data
(63) Continuation-in-part of application No. 12/967,698, filed on Dec. 14, 2010, now Pat. No. 8,563,857.
(60) Provisional application No. 61/288,303, filed on Dec. 20, 2009.

(51) Int. Cl. H02G 3/02

(52) U.S. Cl. CPC H02G 3/02
USPC 403/376

(57) ABSTRACT

An adjustable adapter clip is provided for use with various wall material thicknesses, including lath and plaster walls.

### RELATED APPLICATIONS

The present application is a continuation-in-part of U.S. patent application Ser. No. 12/967,698, filed Dec. 14, 2010 and titled OLD CONSTRUCTION BOX, which claims priority to U.S. Provisional Patent Application Ser. No. 61/288,303, filed Dec. 20, 2009 and titled OLD CONSTRUCTION CUT IN BOX, each of which is incorporated herein in their entireties.

### FIELD OF THE INVENTION

This invention relates to devices which enable consumers to provide electrical boxes in existing, finished walls and ceilings. In particular, the present invention relates to an old construction or old work box having features to enable quick installation without causing damage to the existing wall or ceiling surface.

### BACKGROUND OF THE INVENTION

Old construction boxes, also called “old work boxes” are an electrical box, typically made from metal or plastic, which is used in remodeling applications. The box is used for high voltage applications, such as electrical switches, ceiling fans, and lighting, as well as low voltage applications, such as cables, audio/video wiring, and computer cords.

The old construction box is installed in an existing wall by first providing a hole in the wall. The hole is generally provided so as to maintain a close tolerance between the box and the perimeter of the hole. In some instances, a portion of the box is extended to provide flanges or ears, wherein the flanges increase the width or height of the box so as to prevent the box from being entirely inserted within the hole. In other instances, the old construction box further includes a set of folding tabs that are configured or bent by the user to secure the box within the hole. In some instances, the box further comprises a pair of retractable wings or clamps which are positioned inside the wall. After partial insertion of the box into the hole, the user retracts the wings against an inner surface of the wall to draw the flange portion of the box snug against an outer surface of the wall. In this way, the old construction box is secured within the hole without requiring attachment of the box to an adjacent stud within the wall. However, these securing methods or features reduce the volume of the old construction box, thereby limiting the number of wires that may be safely stored or spliced within the box.

In some instances, a user may desire to install an old construction box in conjunction with metal or plastic wire conduit located within the finished wall. To do this, the user must connect the conduit to the old construction box prior to inserting the box within the hole. The process of inserting the box and connected conduit within the hole requires the box and conduit to be manipulated into place. This process often results in unintended pressures being applied to the box, the conduit and the wall surface, thereby resulting in unwanted damage. Following placement of the box, the user must then repair the wall to complete the installation.

A further challenge exists when attempting to install an old construction box into a lath and plaster wall. Unlike premade dry wall materials, lath and plaster walls are created by applying plaster to lath strips secured to studs forming a wall. The wall thickness of a lath and plaster surface is inconsistent and often varies from approximately 0.5 inches to well over 1.0 inch. Interior wall space also varies greatly, thereby providing the installer with inconsistent circumstances and difficulties when installing an old construction box. Further still, the brittle nature of the plaster material often results in extensive damage and difficulties during the installation process.

Thus, while technologies currently exist that are designed to install an electrical box in a finished wall or ceiling surface, challenges still exist. Accordingly, it would be an improvement in the art to augment or even replace current techniques with other techniques.

### SUMMARY OF THE INVENTION

Some implementations of the present invention provide a flangeless old construction box which is coupled to an inner surface of a provided hole via fasteners and adapter clips. Further, in some implementations an old construction box is provided having lateral flanges, wherein the lateral flanges interact with adapter clips, and wherein the box is coupled to an inner surface of a provided hole via fasteners and the adapter clips. Further, in some implementations of the present invention a method for securing a fastener into a raw surface of a gypsum product is provided.

These and other features and advantages of the present invention will be set forth or will become more fully apparent in the description that follows. The features and advantages may be realized and obtained by means of the instruments and combinations provided herein. Furthermore, the features and advantages of the invention may be learned by the practice of the invention or will be obvious from the description, as set forth hereinafter.

### BRIEF DESCRIPTION OF THE DRAWINGS

FIG. 1 is a perspective view of an installed old construction box in accordance with a representative embodiment of the present invention.

FIG. 2 is an exploded perspective view of an old construction box in accordance with a representative embodiment of the present invention.

FIG. 3 is a cross-section top view of an installed old construction box in accordance with a representative embodiment of the present invention.

FIG. 4 is a perspective view of an adapter clip in accordance with a representative embodiment of the present invention.

FIG. 5 is a detailed cross-section view of an installed old construction box in accordance with a representative embodiment of the present invention.

FIG. 6 is a perspective view of an adjustable adapter clip in accordance with a representative embodiment of the present invention.

FIG. 7 is a cross-section top view of an adjustable adapter clip installed in an opening of a wall in accordance with a representative embodiment of the present invention.

FIG. 8 is a cross-section top view of an adjustable adapter clip installed in an opening of a wall having an intermediate thickness in accordance with a representative embodiment of the present invention.

FIG. 9 is an exploded, perspective view of an adjustable adapter clip and a lath and plaster wall in accordance with a representative embodiment of the present invention.

FIG. 10A is a cross-section top view of an adjustable adapter clip partially installed on a lath and plaster wall in accordance with a representative embodiment of the present invention.

FIG. 10B is a cross-section top view of an adjustable adapter clip having first and second 1-brackets that are temporarily connected by an adhesive strip, the clip being partially installed on a lath and plaster wall in accordance with a representative embodiment of the present invention.

FIG. 11 is a cross-section top view of an adjustable clip installed on a lath and plaster wall in accordance with a representative embodiment of the present invention.

FIG. 12 is a perspective view of an adjustable clip installed on a lath and plaster wall in accordance with a representative embodiment of the present invention.

FIG. 13 is a perspective view of an old construction box coupled to a lath and plaster wall via an adjustable clip in accordance with a representative embodiment of the present invention.

FIG. 14 is cross-section front view of an old construction box installed in an opening in a lath and plaster wall via an adjustable clip in accordance with a representative embodiment of the present invention.

### DETAILED DESCRIPTION OF THE INVENTION

The present invention relates to devices which enable consumers to provide electrical boxes in existing, finished walls and ceilings. In particular, the present invention relates to an old construction or old work box having features to enable quick installation without causing damage to the existing wall or ceiling surface.

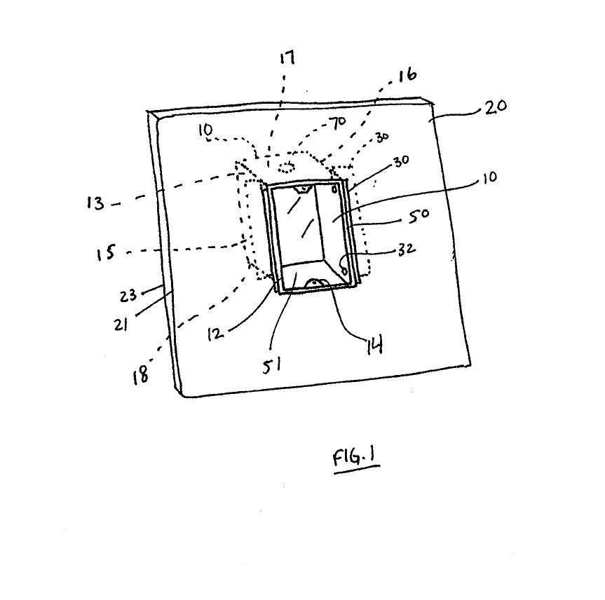

Referring now to FIG. 1, an old construction box 10 is shown as installed in a finished wall surface 20. In some embodiments, wall surface 20 comprises at least one of a gypsum board material, a plaster material, a lath and plaster material, a cement board material, a wood paneling material, a concrete material, a stucco coated wall surface, and combinations thereof. In some embodiments, construction box 10 comprises a box having an opening 12 for receiving and electrical component, such as a light switch or an electrical receptacle, and an outer surface 13. In some embodiments, construction box 10 further comprises mounting tabs 14 whereby to couple an electrical component to the construction box 10.

Construction box 10 may comprise any material compatible with installation of high and/or low voltage electrical wiring and components. For example, in some embodiments construction box 10 comprises at least one of plastic, metal, fiberglass, composite materials, and combinations thereof. Where construction box 10 is used for low voltage wiring and component applications, construction box 10 may comprise a low voltage gang box. In some embodiments, a low voltage gang box comprises a mounting bracket having a front opening and a rear opening to accommodate bending requirements of low voltage wires and cables.

Construction box 10 may comprise any shape, rigidity and/or size necessary to accommodate use for a desire application. For example, in some embodiment construction box 10 comprises a round ceiling box. In other embodiments, construction box 10 comprises a single gang box. Further, in other embodiments construction box 10 comprises a multi-gang box. Still further, in some embodiments construction box 10 comprises a rigid box for use in applications where harsh conditions or physical impact are likely to occur.

In some embodiments, the size, shape, color and material of construction box 10 is selected based on building code requirements of the location where the old construction box 10 is to be installed. Accordingly, one having skill in the art will appreciate that the features of the present invention may be modified as required to comply with regulations, codes, statutes and other governing rules for jurisdictions in which the construction box 10 is used.

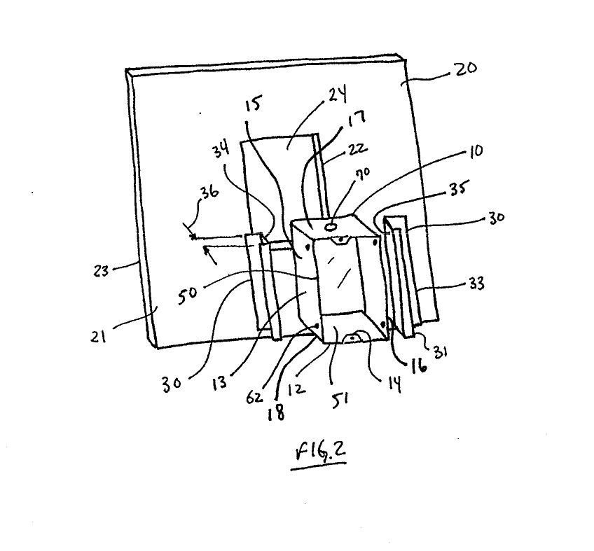

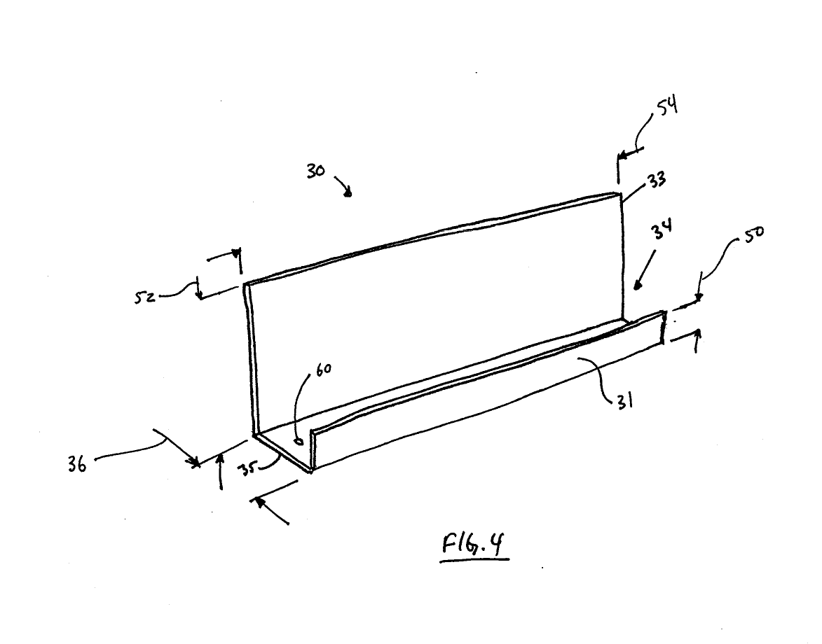

Referring now to FIGS. 1-4, construction box 10 is secured to wall surface 20 via adapter clips 30 and a plurality of fasteners 32. In some embodiments, fasteners 32 comprise at least one of a screw, a metal framing screw, a wood screw, and a sheet rock screw. In some embodiments, adapter clips 30 comprise a channel 34 having a width 36 to compatibly receive an edge 22 of an opening 24 provided in wall surface 20. Adapter clip 30 further comprises a base surface 35 positioned opposite of channel 34 whereby adapter clip 30 forms an interface with outer surface 13 of construction box 10 via base surface 35. Adapter clip 30 may comprise any material compatible with installation of high and/or low voltage electrical wiring and components. For example, in some embodiments adapter clip 30 comprises a metallic material, such as aluminum or galvanized steel. In other embodiments, adapter clip 30 comprises another suitable material, such as plastic, fiberglass or a composite material.

In some embodiments, adapter clips 30 further comprises a front flange 31 and a rear flange 33. Front flange 31 is configured to wrap around a front or exterior surface 21 of wall surface 20, while rear flange 33 is configured to wrap around a rear or interior surface 23 of wall surface 20. Thus, adapter clip 30 provides a protective covering over the portion of edge surface 22 which is positioned within channel 34 of the clip.

In some embodiments, front flange 31 of adapter clip 30 comprises a minimal width 50 to permit concealment of clip 30 by a cover plate 40. Further, in some embodiments rear flange 33 of adapter clip 30 comprises an extended width 52 to increase the surface area of interface between adapter clip 30 and wall surface 20. By increasing the surface area of interface between adapter clip 30 and wall surface 20, the installed construction box 10 is more securely anchored within opening 24. In some embodiments, adapter clip 30 further comprises a length 54 which is approximately equal to a length or width of opening 24. In other embodiments, adapter clip 30 comprises a length 54 which is less than a length or width of opening 24. In some embodiments, construction box 10 is installed in opening 24 with a pair of oppositely positioned adapter clips 30. In other embodiments, construction box 10 is installed in opening 24 with more than two adapter clips 30. Further, in some embodiments construction box 10 is installed in opening 24 with a single adapter clip 30, wherein the single adapter clip 30 contacts at least two adjacent sides of construction box 10. Further still, in some embodiments construction box 10 is installed in opening 24 with a single adapter clip 30, wherein the single adapter clip 30 contacts a single side surface of construction box 10.

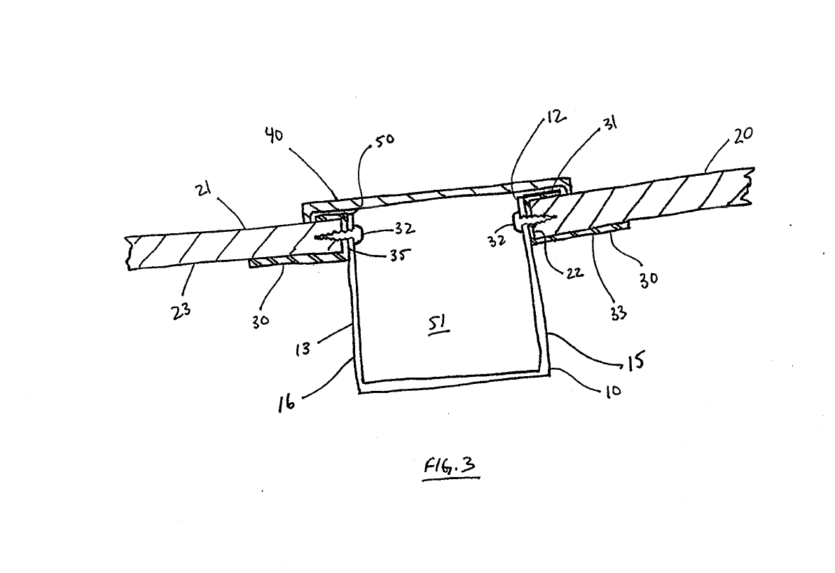

In some embodiments, adapter clip 30 further comprises pilot holes 60 whereby to receive fasteners 32. Further, in some embodiments old construction box 10 further comprises pilot holes 62 whereby to receive fasteners 32. Thus, in some embodiments old construction box 10 is secured within opening 24 by aligning pilot holes 60 and 62 and threadedly inserting fasteners 32 through said pilot holes and into wall surface 20, as shown in FIGS. 1 and 3.

In some embodiments, the position of pilot holes 60 and 62 are determined by local code. In other embodiments, old construction box 10 comprises divots or physical markers in place of pilot holes. The divots or physical markers provide an indication of where to place fasteners 32 so as to secure construction box 10 in opening 24 in compliance with local codes.

In some embodiments, construction box 10 further comprises a knockout hole 70 whereby to secure a cable coupler or a flexible conduit. The flange-less design of construction box 10 permits installation of the box within opening 24 following attachment of the flexible conduit to the box. Unlike traditional old construction boxes, the subsequent installation of construction box 10 and attached conduit line may be completed without damaging wall surface 20. Accordingly, once attached, the conduit and construction box 10 are inserted into opening 24 and positioned such that opening 12 of box 10 is flush with front flange 31 and exterior surface 21 of wall surface 20. Construction box 10 is then secured to wall 20 via fasteners 32.

In some embodiments, it is desirable to attach construction box 10 to a conduit line where the available length of conduit line is limited. Accordingly, in some embodiments construction box 10 is inserted entirely within opening 24, such that opening 12 of box 10 is positioned within the wall. Construction box 10 is then lowered within the wall such that knockout hole 70 is accessible via opening 24. The conduit line is then fastened to knockout hole 70 while construction box 10 is held within the wall. Following securement of the conduit line, construction box 10 positioned within opening 24 such that opening 12 of box 10 is flush with front flange 31 and exterior surface 21 of wall surface 20. Construction box 10 is then secured to wall 20 via fasteners 32.

Therefore, in some embodiments a method for installing old construction box 10 comprises: 1) providing an opening 24 in a wall surface 20; 2) fitting adapter clips 30 over an edge of opening 24; 3) positioning old construction box 10 within opening 24 such that an opening 12 of construction box 10 is approximately flush with an exterior surface 21 of wall surface 20; and 4) securing construction box 10 within opening 24 by driving fasteners 32 through construction box 10 and adapter clips 30 and into wall surface 20. Where a user desires to attach a conduit line, the method further includes the step of attaching the conduit line to a knockout hole 70 of construction box 10, as discussed above.

Further, in some embodiments a method for manufacturing an old construction box 10 comprises: 1) providing a construction box having an opening and an outer surface; 2) providing an adapter clip having a channel for receiving an edge surface of an opening in a finished wall surface, the adapter clip further having a base surface for forming an interface with the outer surface of the construction box; and 3) providing a fastener whereby to secure the construction box within an opening in a finished wall surface by driving the fastener through a portion of the construction box and the adapter clip, and into the edge surface of the opening in the finished wall surface.

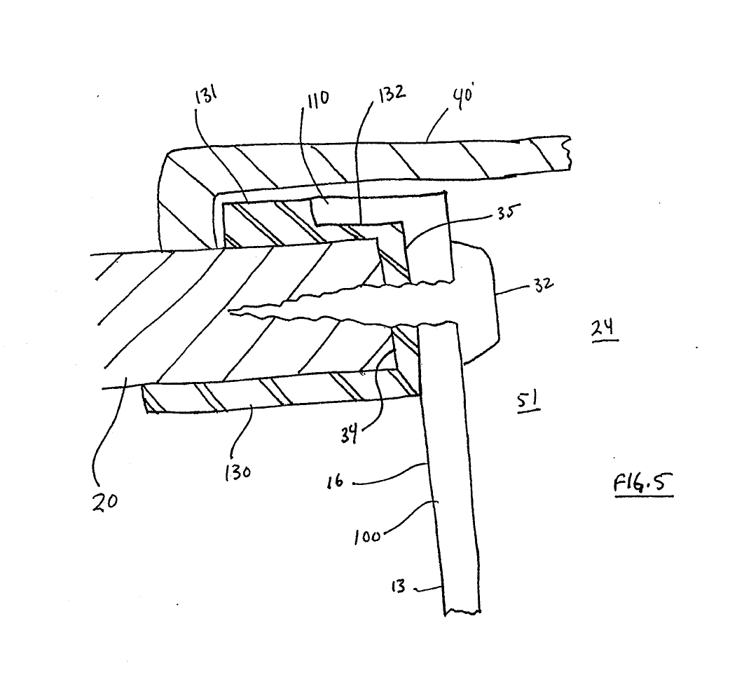

Referring now to FIG. 5, in some embodiments old construction box 100 further comprises an external flange 110. External flange 110 is provided to prevent complete insertion of construction box 100 within opening 24 of wall surface 20. In some embodiments, external flange 110 is provided to assist a user in accurately positioning construction box 100 within opening 24.

In some embodiments, adapter clip 130 is modified to include a rabbeted surface 132 to compensate for the thickness of external flange 110. External flange 110 is seated within rabbeted surface 132 so that external flange 110 is approximately flush with the outer surface of front flange 131. Thus, adapter clip 130 and external flange 110 may be concealed with a cover plate 40 following installation of construction box 100.

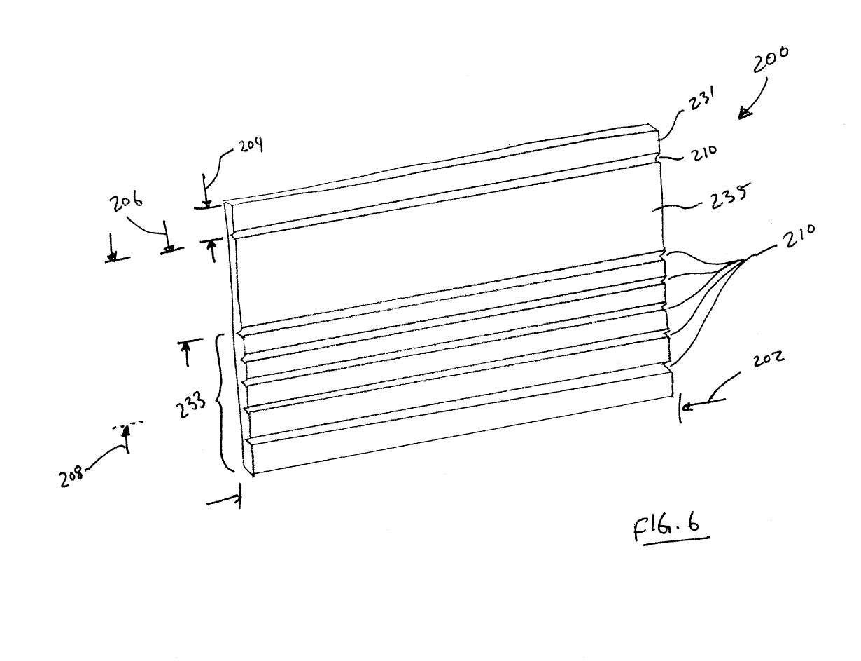

The present invention may further include an adapter clip that may be adjusted by the user to accommodate any wall thickness. Referring now to FIG. 6, an adjustable adapter clip 200 is shown. Adapter clip 200 may comprises any desired dimensions. Generally, adapter clip 200 comprises a length 202 that is approximately equal to, or slightly less than the height of an old construction box. In one embodiment, length 202 is approximately 3.25 inches.

In some instances, adapter clip 200 comprises a flat, 26 gauge metal sheet that is divided into various section across length 202 via scored grooves 210. Grooves 210 are provided to assist the user in easily bending clip 200 along length 202 to provide a U-channel structure. The U-channel is then placed over the edge surface 22 of a wall opening, as described above.

A front flange 231 is provided and comprises a height 204 that is easily covered by a wall plate, following installation. Front flange 231 may be bent by the user, or may be pre-bent. In some instances, height 204 is approximately 0.125 inches. In other instance, height 204 is approximately 0.25 inches.

A base 235 is further provided and configured to be placed over an edge surface of a wall opening. As is known and appreciated in the art, wall materials vary in thickness from 0.25 inches to 1.00 inches. Base 235 of adjustable adapter 200 comprises a minimum height 206 that is approximately equal to a minimum wall material thickness. For example, in some instances height 206 is 0.25 inches. In other instances, height 206 is 0.5 inches.

A final height 208 of base 235 may be selected by bending rear flange 233 along length 202 of base 235 via any of the grooves 210 of rear flange 233. Grooves 210 of rear flange 233 are spaced at increments that permit fine tuning of final height 208 to accommodate customary wall material thicknesses. For example, in some instances grooves 210 are spaced at 0.125 inches. In other instances, grooves 201 are spaced at 0.25 inch increments. When adapter 200 is bent along a groove of rear flange 233, the remaining grooves of rear flange 233 are left to wrap around a rear or inner surface of the wall. Thus, the user may adjust adapter 200 to achieve a final height 208 for any wall thickness.

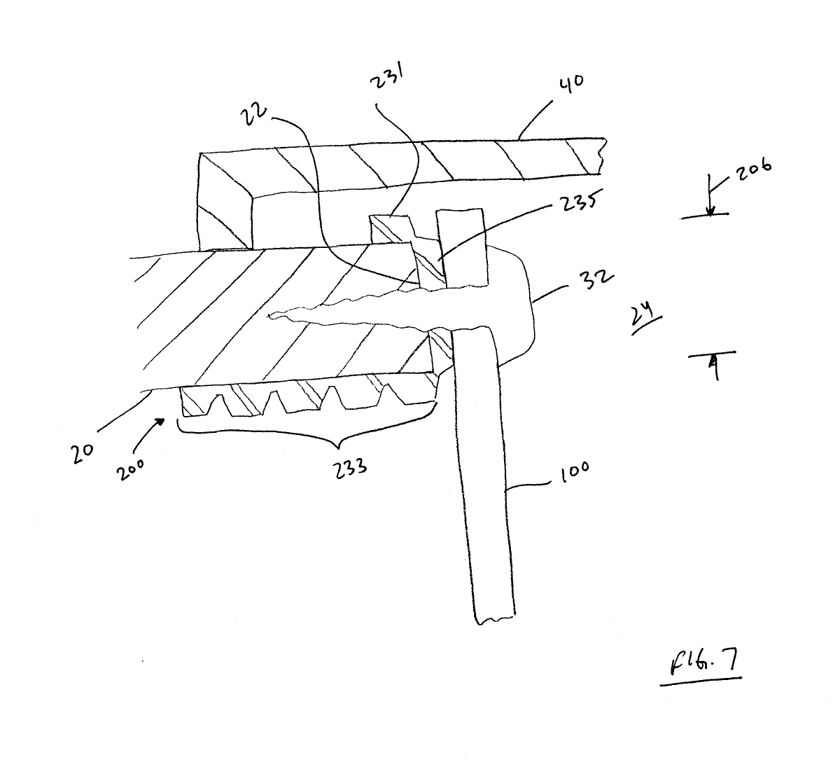

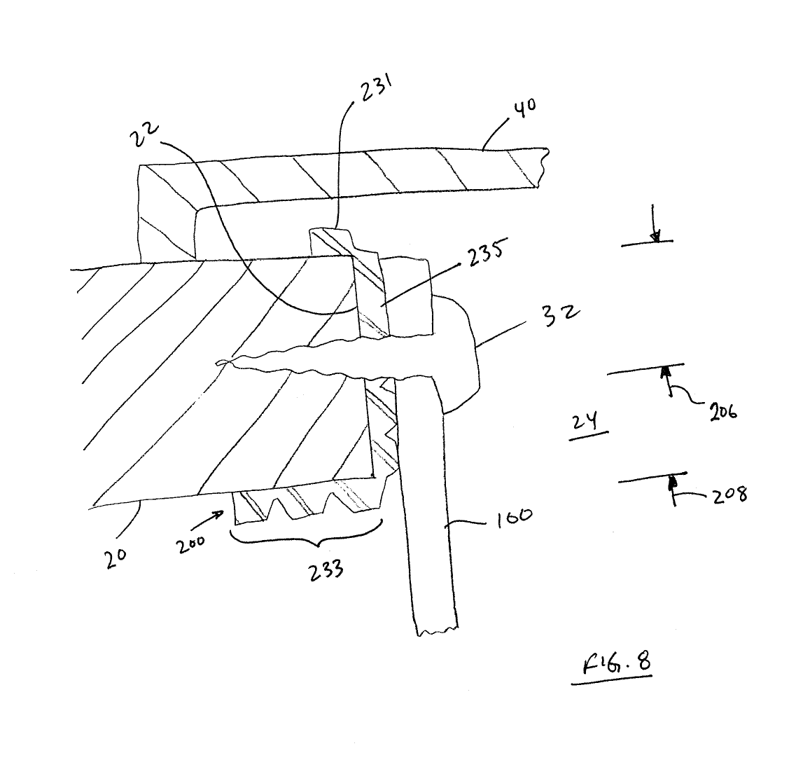

Referring now to FIG. 7, adjustable adapter clip 200 is installed into a wall opening 24, wherein the thickness of the wall material is equal to height 206 of base 235. In FIG. 8, adjustable adapter clip 200 is installed into a wall opening 24, wherein the thickness of the wall material is greater than height 206 of base 235. Accordingly, final height 208 was achieved by bending adapter 200 along length 202 via a groove 210 of rear flange 233. The remaining grooves 210 of rear flange 233 are positioned on the inner surface of wall 20 and act as a rear flange, thereby maintaining the position of base 235, and additional increments of the rear flange that were added to base 235, on edge 22.

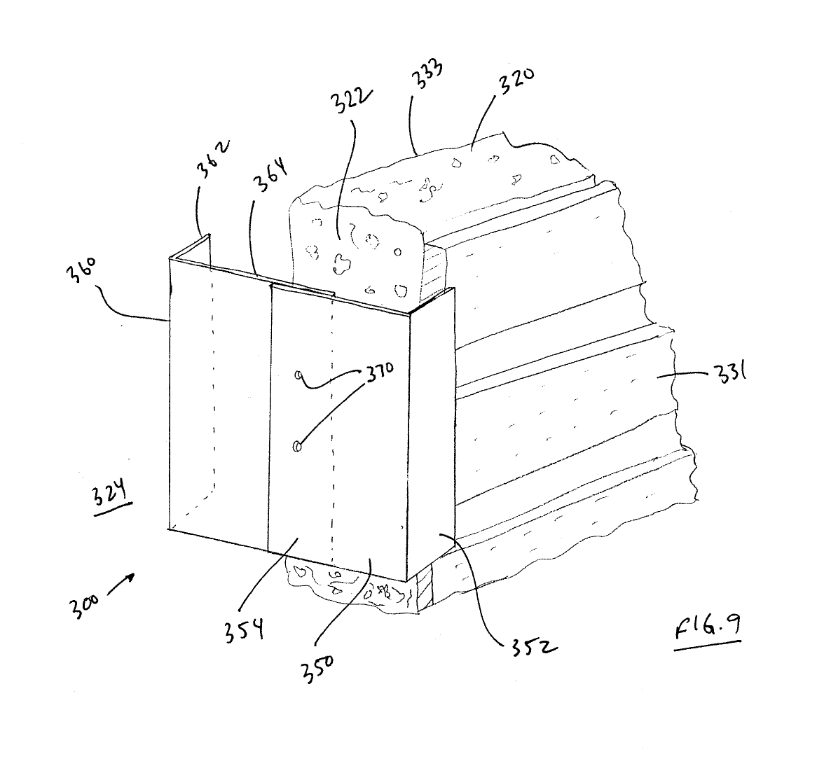

Some embodiments of the present invention provide an adjustable adapter clip that may be used to cover edges of wall opening provided in lath and plaster walls. Referring generally to FIGS. 9-14, the present invention may further comprise an adjustable adapter clip 300 comprised of an interior L-bracket 350 and an exterior L-bracket 360 that are slidably interfaced to form a U-channel which covers an edge 322 of an opening 324 in a lath and plaster wall 320.

Interior and exterior L-brackets 350 and 360 generally comprise a flange 352/362 and an extension 354/364. The flanges are configured to abut or interface with an interior or exterior surface of wall 320. Flanges 352 and 362 generally comprise a length that permits the flange to be concealed under the faceplate 40, following installation. The extensions overlap one another to form a U-channel that covers the edge surface 322. In some instances, extensions 354 and 364 comprise a length sufficient to ensure that the extensions are capable of overlapping one another by no less than 0.375 inches. In some embodiments, each extension comprises a length of 0.75 inches. In other instances, the installed L-brackets form a U-channel configured to receive an edge surface of a wall having a thickness from approximately 0.75 inches to 1.5 inches.

Extensions 354 and 364 are slidably adjusted within opening 324 to position flange 352 on the interior surface 331 of wall 320, and to position flange 362 on the exterior surface 333 of wall 320. Thus, extension 354 and 364 overlap across edge surface 322.

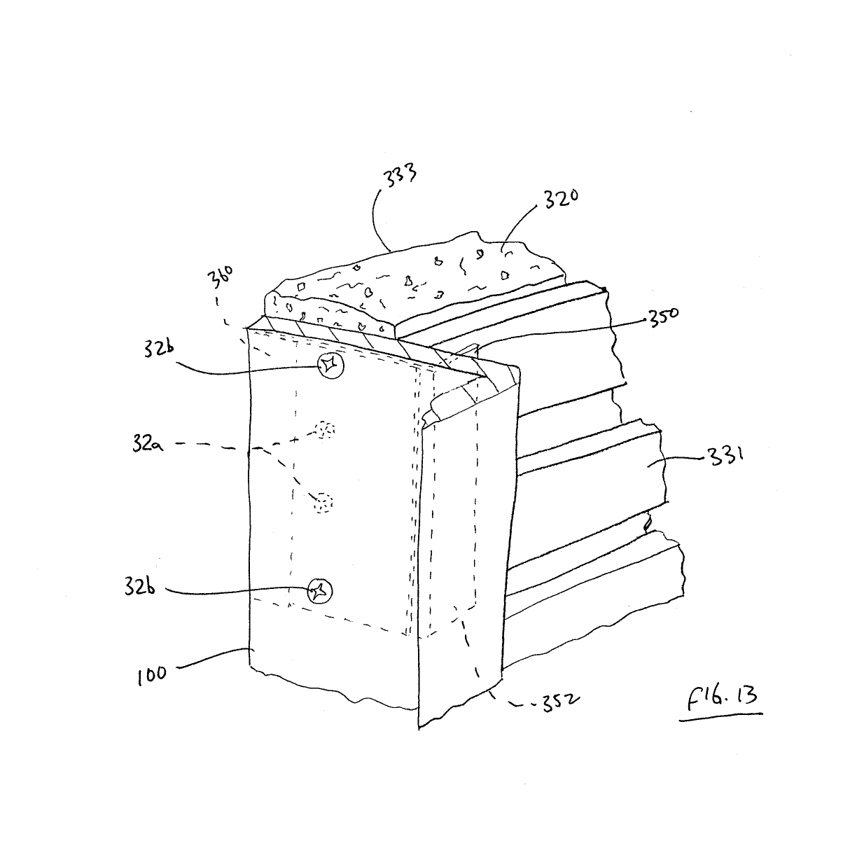

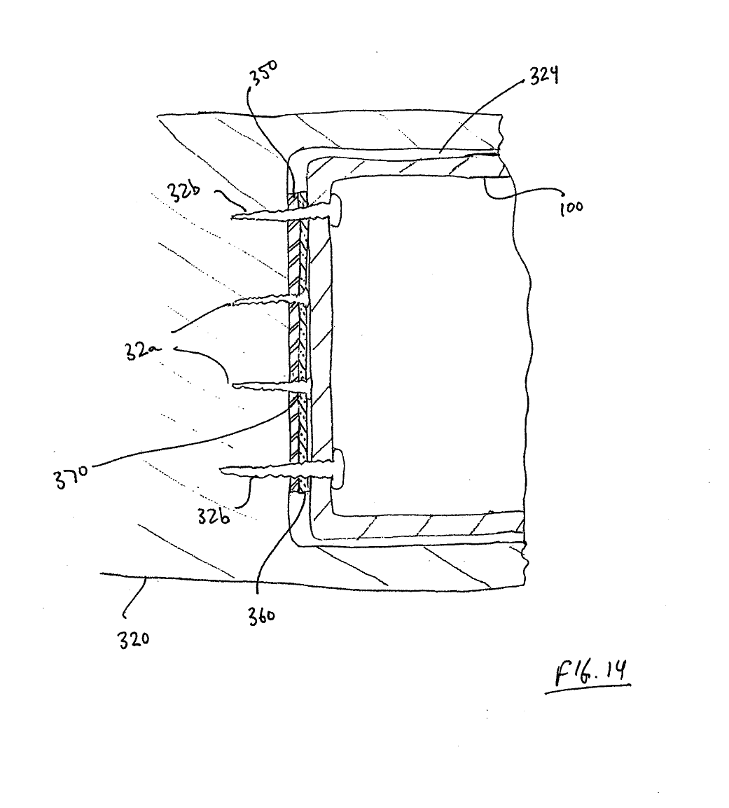

In some instances, at least one of the extensions comprises one or more pilot holes 370 for receiving a fastener 32a intended to secure brackets 350 and 360 to wall 320, as shown in FIGS. 13 and 14. Pilot holes 370 are located on the extension at a position that does not interfere with the placement of fasteners 32b that are used to secure the construction box 100 to adjustable adapter 300 and wall 320. In some instances, building codes require that any portion of a fastener located within the interior of a construction box 100 be positioned no more than 0.375 inches from the box's outer edge. Accordingly, in some instances pilot holes 370 are positioned inwardly from the upper and lower edges of the L-bracket a distance that is greater than 0.375 inches. Following placement of fasteners 32a, construction box is inserted into opening 324 and secured to wall 320 and L-brackets 350 and 360 via fasteners 32b, wherein the placement of fasteners 32b comply with the code requirements, and whereby the placement of fasteners 32a do not interfere with the placement of fasteners 32b.

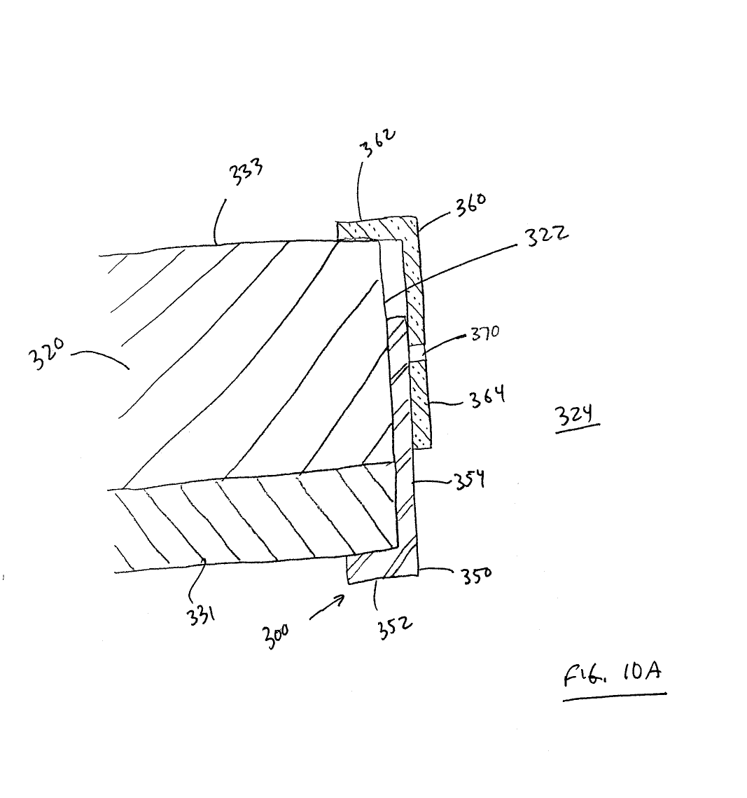

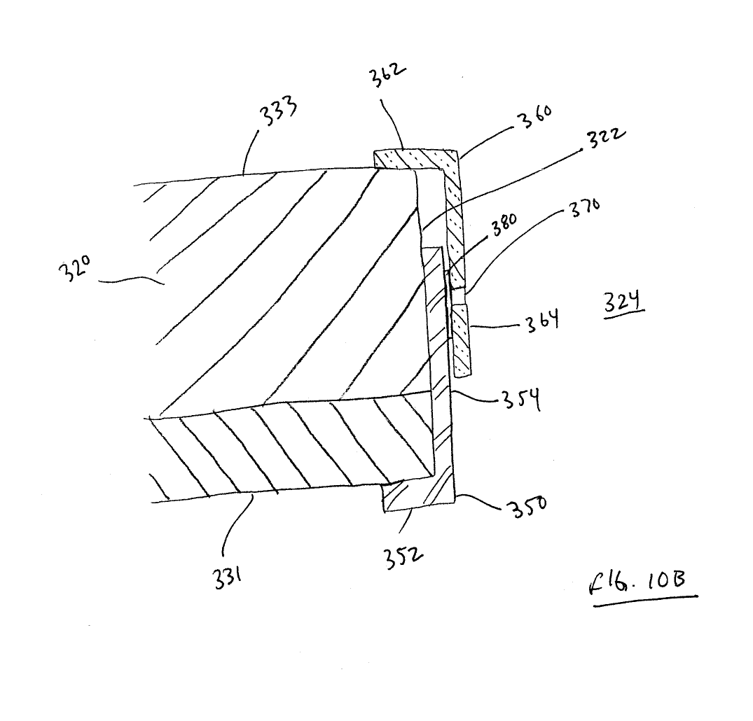

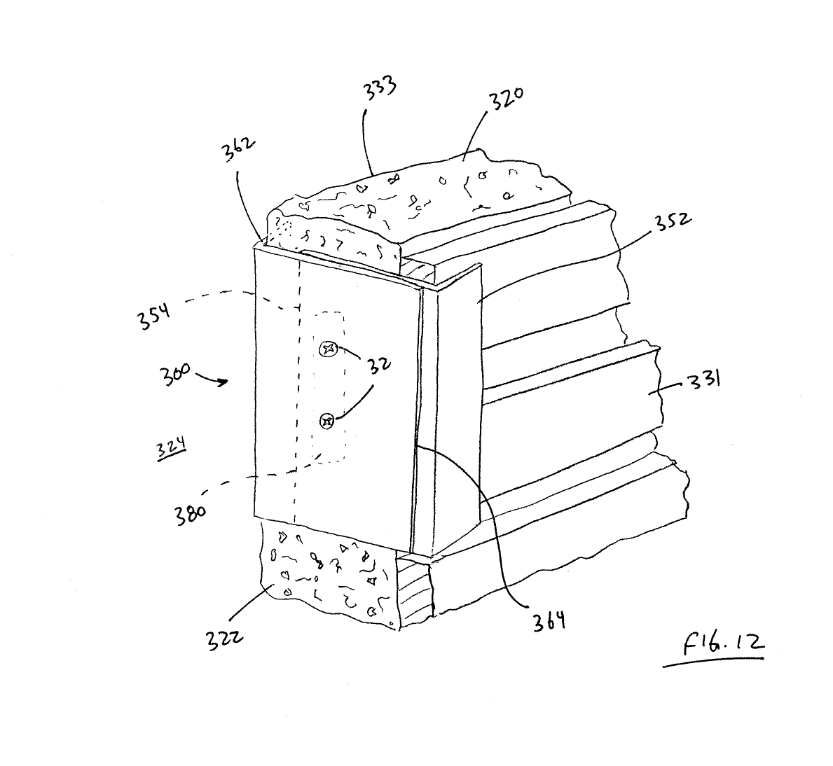

Adjustable adapter clip 300 is installed into opening 324 by first positioning interior L-bracket 350 within opening 324 so that rear flange 352 is seated on interior wall surface 331. Exterior L-bracket 360 is then placed into opening 324 so that extension 364 overlaps extension 354. Exterior L-bracket 360 is then slid into opening 324 until front flange 362 abuts exterior surface 333, as shown in FIGS. 10A, 10B and 12. The respective positions of the L-brackets are held in place manually until a fastener 32 is driven into edge surface 322 via pilot holes 370.

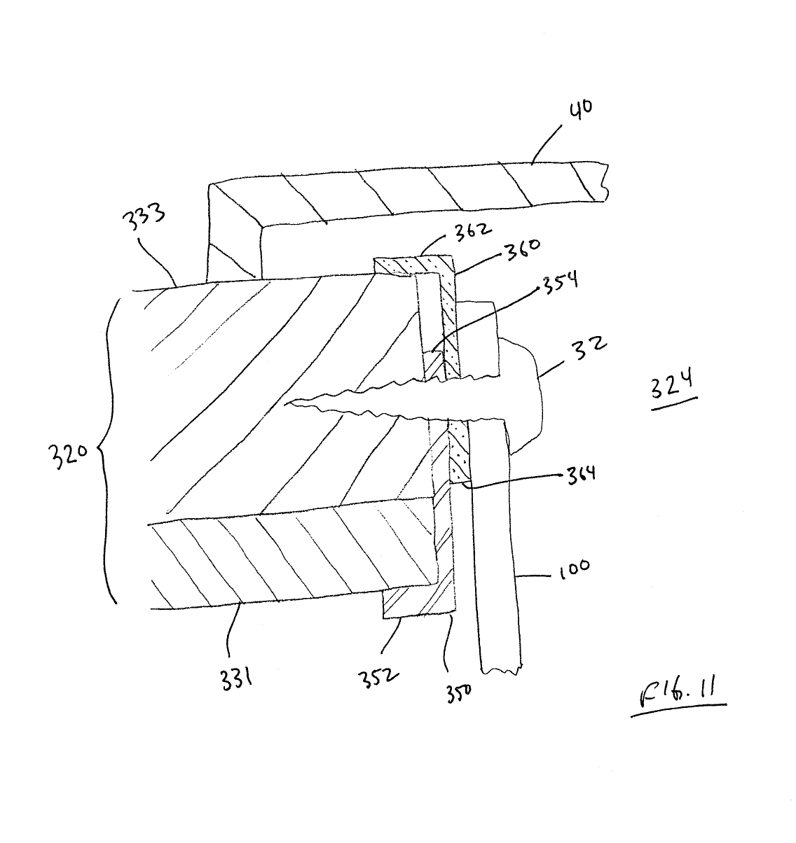

In some instances, an adhesive strip 380 is provided between extensions 354 and 364, as shown in FIG. 10B. Adhesive strip 380 may comprise any material capable of securing together extensions 354 and 364. In some embodiments, adhesive strip 380 temporarily secures together extensions 354 and 364 until a fastener 32 is driven through the extensions. In other instances, adhesive strip 380 secures together extensions 354 and 364 until a construction box is inserted into the opening 324 and a fastener 32 is driven through the construction box and the extensions, as shown in FIG. 11.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps are disclosed herein, and without intending to publicly dedicate any patentable subject matter.

What is claimed is:

1. An adjustable adapter clip, comprising:
an interior L-bracket having an exterior flange and a first extension;
an exterior L-bracket having an interior flange and a second extension, wherein the first and second extensions overlap to form a U-channel having a width to receive an edge surface of a wall opening, and wherein a fastener is driven through the overlapped first and second extensions to secure the adjustable adapter clip to the edge surface of the wall opening.
